(19) United States
(12) Patent Application Publication
(10) Pub. No.: US 2006/0082796 A1
(43) Pub. Date: Apr. 20, 2006

(54) Method and apparatus for printing image at a print speed determined by the number of printing lines

(75) Inventor: Jong-Un Jeong, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/226,381

(22) Filed: Sep. 15, 2005

(30) Foreign Application Priority Data
Oct. 18, 2004 (KR) 2004-0083236

(51) Int. Cl. G06K 15/10

(52) U.S. Cl. 358/1.5; 358/1.13

(57) ABSTRACT

Image data is printed by a printing apparatus by calculating the number of print lines of image data to be printed, determining a print speed of the image data according to the calculated number of print lines, and printing the image data at the print speed. When image data is to be printed, the image data is printed at a print speed which is determined using the previously calculated number of print lines. Thus, deterioration of image quality due to discontinuation of printing during printing can be prevented. Also, high speed printing using memory of limited storage capacity is possible.

### CROSS-REFERENCE TO RELATED APPLICATIONS

This application claims the benefit under 35 U.S.C. § 119(a) of Korean Patent Application No. 10-2004-0083236, filed on Oct. 18, 2004, in the Korean Intellectual Property Office, the entire disclosure of which is hereby incorporated by reference.

### BACKGROUND OF THE INVENTION

1. Field of the Invention

The present invention relates to a method and apparatus for printing image data. More particularly, the present invention relates to a method and apparatus for determining a print speed based on the number of printing lines of image data to be printed and printing an image at that print speed.

2. Description of the Related Art

In general, printing apparatuses convert text created by a user using an application program or an image photographed using a digital camera to encode data and output the data to a recording medium in a format which can be visually recognized by the user.

Recently, with developments in both data processing technology and printing technology, photo printers for printing large files of image data (such as photographic image data from digital cameras) have become popular. In general, a photo printer receives image data from a PC, a digital camera, or a portable storage medium, and prints the image data. The capacity of the memory included in a printing apparatus must be very large to store all the image data received from an external device in memory and then print the image data. Thus, to print image data using memory with a limited storage capacity, the image data is divided into portions having appropriate, smaller sizes that correspond to the storage capacity of the memory. The divided image data is then sequentially printed to form a complete image.

FIG. 1 is a block diagram illustrating the configuration of a typical all-in-one printer. The all-in-one apparatus includes a central processing unit 100, a memory portion 110, a user input/output (I/O) portion 120, a scan portion 130, a modem 140, a network control unit 150, a printing portion 160, a sensor portion 170, and a PC interface portion 180.

The central processing unit 100 controls the overall operation of the all-in-one printer according to a preset program and stores control program data, protocol data, and image data to be printed in the memory portion 110. Since the storage capacity of the memory portion 110 is smaller than the file size of the image data to be printed, the central processing unit 100 divides the image data to be printed into image data having a particular size and sequentially stores the divided image data in the memory portion 110 for printing.

The user I/O portion 120 includes a plurality of keys and a display device. The user I/O portion 120 receives a key input by a user, generates a signal corresponding to the key input, and provides the generated signal to the central processing unit 100. The user I/O portion 120 receives information on the operation of the all-in-one printer from the central processing unit 100 and displays the status of the all-in-one printer.

The scan portion 130 generates text data from a scanned document under the control of the central processing unit 100 and outputs the text data to the central processing unit 100. The modem 140 modulates an output signal of the central processing unit 100 to an analog signal and outputs the modulated analog signal. The modem 140 also modulates an analog signal input to the all-in-one printer and outputs the modulated signal to the central processing unit 100. The network control unit 150 interfaces the modem 140 to a telephone line.

The printing portion 160 receives the image data to be printed from the central processing unit 100 and prints an image on a recording medium. The sensor portion 170 detects the existence of the recording medium or the remaining capacity of the recording medium and provides the result of the detection to the central processing unit 100. The PC interface portion 180 interfaces the central processing unit 100 and a user's PC so that the user can use the printing and scanning functions of the all-in-one printer through the PC.

When an image is printed using the above-described conventional method, printing may stop because the size of the image data stored in the memory and the print speed do not match each other. This stoppage deteriorates the quality of the printed image. To solve this problem, the print speed may be decreased according to the file size of the image data stored in the memory, or the printing apparatus can be provided with a memory having a large storage capacity that is sufficient to store all of the image data. Neither solution is optimal.

Accordingly, there is a need for an improved method and apparatus for printing an image with an image data size larger than the storage capacity of memory in a printer.

### SUMMARY OF THE INVENTION

An aspect of the present invention is to solve at least the above problems and/or disadvantages and to provide at least the advantages described below. Accordingly, an aspect of the present invention is to provide a method and apparatus for printing an image at a print speed that is determined by the number of print lines of image data to be printed.

According to an aspect of the present invention, a method of printing image data in a printing apparatus comprises calculating the number of print lines of image data to be printed, determining a print speed of the image data according to the calculated number of print lines, and printing the image data at the print speed.

According to another aspect of the present invention, a method of printing image data in a printing apparatus comprises dividing image data to be printed into image data of a predetermined size, decoding the divided image data, calculating the number of print lines of the decoded image data, determining a print speed of the divided image data using the calculated number of print lines, printing the divided image data at the determined print speed, and repeating the steps from the decoding of the divided image data to the printing of the divided image data until all of the divided image data is printed.

The image data to be printed may be compressed using a conventional compression format, such as the JPEG (Joint Photographic Experts Group) format set forth in ITU-T Recommendation T.81, the Group 3 and 4 facsimile formats set forth in ITU-T Recommendations T4 and T6, or the JBIG (Joint Bi-level Image experts Group) format set forth in ITU-T Recommendation T.82.

The print speed may be a speed of a motor to drive the printing apparatus.

The decoded image data and the calculated number of print lines with respect to the image data may be alternately stored in two memories according to a print order of the decoded image data.

According to another aspect of the present invention, an apparatus for printing image data comprises a line calculation portion calculating a number of print lines of image data to be printed, a print speed determination portion determining a print speed of the image data based on the calculated number of print lines, and a printing portion printing the image data at the determined print speed.

According to another aspect of the present invention, an apparatus for printing image data comprises a decoder dividing image data to be printed into image data of a predetermined size and decoding the divided image data, a line calculation portion calculating a number of print lines of the decoded image data, a print speed determination portion determining a print speed of the divided image data based on the calculated number of print lines, and a printing portion printing the divided image data at the determined print speed.

The image data to be printed may be compressed by one of the JPEG, T4/T6, or JBIG formats. The print speed may be a speed of a motor to drive the printing apparatus.

The print speed determination portion may comprise a memory portion storing the image data and the number of print lines of the image data, a memory control portion allowing the decoded image data and the number of print lines of the image data to be stored in the memory, and a speed calculation portion calculating the print speed of the image data according to the number of print lines of the image data stored in the memory.

The memory portion may comprise two memories in which the decoded image data and the number of print lines of the image data are alternately stored according to a print order of the decoded image data.

According to another aspect of the present invention, a computer-readable recording medium having a set of instructions stored therein, which when executed by a computer, causes the computer to print image data by performing the steps of the methods defined above, is provided.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a block diagram illustrating the configuration of a conventional all-in-one printer;

FIG. 2 is a block diagram illustrating the overall configuration of a printing apparatus for printing an image at a print speed determined by the number of printing lines of image data to be printed, according to an embodiment of the present invention;

FIG. 3 is a block diagram illustrating an example of the print speed determination portion of FIG. 2;

FIG. 4 is a flow chart for explaining a method of printing an image at a print speed determined by the number of printing lines of image data to be printed, according to an embodiment of the present invention; and

FIG. 5 is a flow chart for explaining an exemplary method of storing image data to be printed in a memory, according to an embodiment of the present invention.

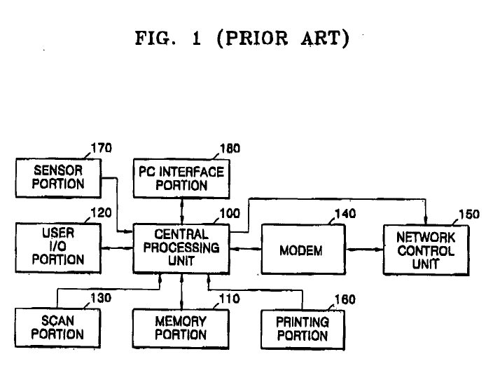

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

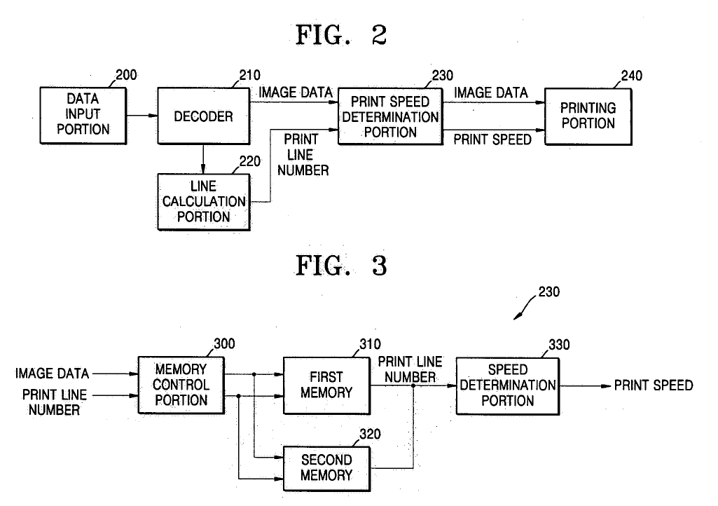

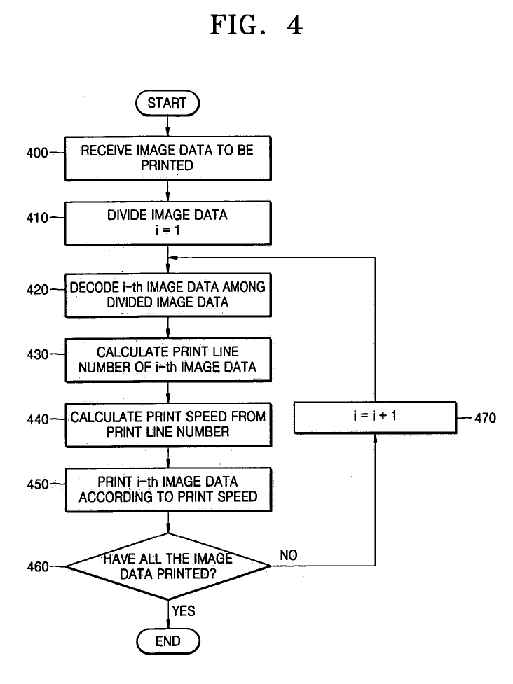

Referring to FIG. 2, a printing apparatus for printing an image at a print speed determined by the number of printing lines of image data to be printed according to an embodiment of the present invention includes a data input portion 200, a decoder 210, a line calculation portion 220, a print speed determination portion 230, and a printing portion 240. The operation of the printing apparatus will be described with reference to the flow chart of FIG. 4, which shows the printing method according to an embodiment of the present invention.

The data input portion 200 receives image data to be printed from a PC, a digital camera, a scanner, a fax, a portable storage medium such as a smart card, or any other suitable data source (Step 400). The image data, such as a picture, is typically compressed using an image compression format such as the JPEG, T4/T6, or JBIG formats.

The decoder 210 divides the input image data into image data of a particular size according to the capacity of a memory (not shown) where the image data is stored (Step 410). The decoder also decodes the first image data of the divided image data (Step 420). The divided image data has a preset size before being decoded. After being decoded, however, the divided image data has different data sizes so that the numbers of lines to be actually printed varies.

The line calculation portion 220 receives the decoded image data from the decoder 210 and calculates the number of print lines of the image data (Step 430). When the decoded image data is printed on a recording medium, the size of image data corresponding to one print line is fixed. Therefore, the number of print lines can be calculated from the size of the decoded image data.

The print speed determination portion 230 receives the number of print lines of the divided image data from the line calculation portion 220, calculates a print speed of the image data from the input number of print lines, and outputs the calculated print speed (Step 440). As the number of print lines increases, the print speed of the image data is determined to be slower. The relationship between the number of print lines and the print speed can be adjusted according to the performance of the print portion 240.

The print portion 240 prints the image data according to the calculated print speed (Step 450). The print portion 240 then repeats the steps from Step 420 to Step 450 until all the divided image data is completely printed (Step 470).

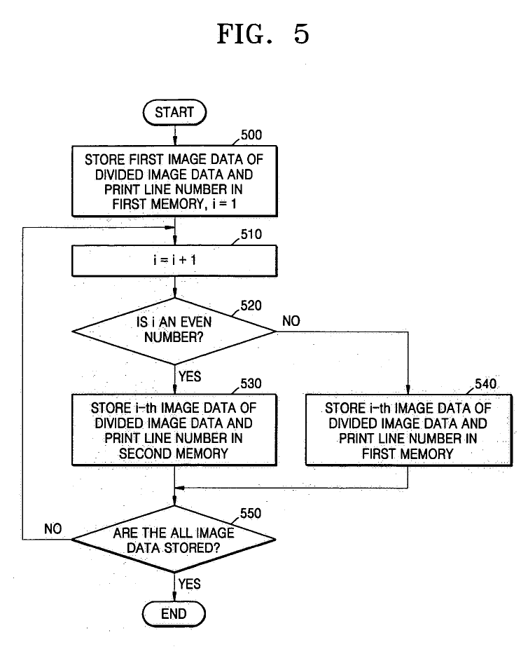

FIG. 3 is a block diagram illustrating an example of the print speed determination portion 230 of FIG. 2. Referring to FIG. 3, the print speed determination portion 230 includes a memory control portion 300, a first memory 310, a second memory 320, and a speed determination portion 330. The operation of the print speed determination portion 230 will be described with reference to the flow chart of FIG. 5, which shows a method of storing image data to be printed in a memory.

The memory control portion 300 receives the first decoded image data from the decoder 210 and the number of print lines of the first decoded image data from the line calculation portion 220 and stores the received data in a first memory 310 (Step 500). The memory control portion 300 then receives the second decoded image data and the number of print lines of the second decoded image data (Step 510). The memory control portion checks the print order of the image data (Step 520), and stores the image data in the second memory 320 (Step 530).

Next, the memory control portion 300 receives the third decoded image data and the number of print lines of the third decoded image data (Step 510). The memory control portion checks the print order of the image data (Step 520), and stores the image data in the first memory 310 (Step 540).

The memory control portion 300 checks whether all the divided image data has been stored in the first and second memories 310 and 320 and printed (Step 550), repeats the steps from Step 510 to Step 550 until printing is completed, and alternately stores the divided image data in the first and second memories 310 and 320 according to the print order.

The speed determination portion 330 reads the number of print lines of the image data alternately stored in the first and second memories 310 and 320, calculates a print speed of the image data from the number of print lines, and outputs the calculated print speed.

In another embodiment of the invention, computer readable codes, or instruction sets, for performing the above-described methods are stored on a computer readable recording medium. As used herein, computer readable recording medium means any data storage device that can store data which can be read by a computer system. Examples of computer readable recording mediums include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, according to the present invention, when image data is to be printed, the image data is printed at a print speed which is determined using the previously calculated number of print lines. Thus, deterioration of an image quality due to discontinuation of printing during printing can be prevented. Also, high speed printing using memory of limited storage capacity is possible by using the properties of the image data.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method of printing image data in a printing apparatus, the method comprising the steps of:
a) calculating a number of print lines of image data to be printed;
b) determining a print speed of the image data according to the calculated number of print lines; and
c) printing the image data at the print speed.

2. A method of printing image data in a printing apparatus, the method comprising the steps of:
a) dividing image data to be printed into image data of a predetermined size;
b) decoding the divided image data;
c) calculating a number of print lines of the decoded image data;
d) determining a print speed of the divided image data using the calculated number of print lines;
e) printing the divided image data at the determined print speed; and
f) repeating steps b)-e) until all the divided image data is printed.

3. The method as claimed in claim 2, wherein
the image data to be printed is compressed with one of the JPEG (Joint Photographic Experts Group), T4/T6, or JBIG (Joint Bi-level Image experts Group) formats.

4. The method as claimed in claim 2, wherein
the print speed is a speed of a motor to drive the printing apparatus.

5. The method as claimed in claim 2, wherein
the decoded image data and the calculated number of print lines with respect to the image data are alternately stored in two memories according to a print order of the decoded image data.

6. An apparatus for printing image data comprising:
a line calculation portion calculating a number of print lines of image data to be printed;
a print speed determination portion determining a print speed of the image data based on the calculated number of print lines; and
a printing portion printing the image data at the determined print speed.

7. An apparatus for printing image data comprising:
a decoder dividing image data to be printed into image data of a predetermined size and decoding the divided image data;
a line calculation portion calculating a number of print lines of the decoded image data;
a print speed determination portion determining a print speed of each of the divided image data based on the calculated number of print lines; and
a printing portion printing the divided image data at the determined print speed.

8. The apparatus as claimed in claim 7, wherein
the image data to be printed is compressed with one of the JPEG (Joint Photographic Experts Group), T4/T6, or JBIG (Joint Bi-level Image experts Group) formats.

9. The apparatus as claimed in claim 7, wherein the print speed determination portion comprises:
a memory portion storing the image data and the number of print lines of the image data;
a memory control portion allowing the decoded image data and the number of print lines of the image data to be stored in the memory; and
a speed calculation portion calculating the print speed of the image data according to the number of print lines of the image data stored in the memory.

10. The apparatus as claimed in claim 9, wherein
the memory portion comprises two memories in which the decoded image data and the number of print lines of the image data are alternately stored according to a print order of the decoded image data.

11. The apparatus as claimed in claim 7, wherein
the print speed is a speed of a motor to drive the printing apparatus.

12. A computer-readable recording medium having a set of instructions stored therein which, when executed by a computer, causes the computer to print image data by performing the steps of:
a) calculating a number of print lines of image data to be printed;
b) determining a print speed of the image data according to the calculated number of print lines; and
c) printing the image data at the print speed.

13. A computer-readable recording medium having a set of instructions stored therein which, when executed by a computer, causes the computer to print image data by performing the steps of:
a) dividing image data to be printed into image data of a predetermined size;
b) decoding the divided image data;
c) calculating a number of print lines of the decoded image data;
d) determining a print speed of the divided image data using the calculated number of print lines;
e) printing the divided image data at the determined print speed; and
f) repeating steps b)-e) until all the divided image data is printed.

14. The computer-readable recording medium as claimed in claim 13, wherein
the image data to be printed is compressed with one of the JPEG (Joint Photographic Experts Group), T4/T6, or JBIG (Joint Bi-level Image experts Group) formats.

15. The computer-readable recording medium as claimed in claim 13, wherein
the print speed is a speed of a motor to drive the printing apparatus.

16. The computer-readable recording medium as claimed in claim 13, further comprising instructions for performing the step of:
alternately storing the decoded image data and the calculated number of print lines with respect to the image data in two memories according to a print order of the decoded image data.
